(19) United States
(12) Patent Application Publication
(10) Pub. No.: US 2008/0165135 A1
(43) Pub. Date: Jul. 10, 2008

(54) FUNCTIONAL EXPANSION SYSTEM FOR A TOUCH PAD

(76) Inventors: Jao-Ching Lin, Taipei (TW); Lin-Abel Chu, Taipei (TW); Chung-Yi Shen, Taipei (TW)

Correspondence Address: G. LINK CO., LTD., 3550 BELL ROAD, MINOOKA, IL, 60447, US

(21) Appl. No.: 11/621,811

(22) Filed: Jan. 10, 2007

(51) Int. Cl. G06F 3/041

(52) U.S. Cl. 345/173

(57) ABSTRACT

A functional expansion system for a touch pad of an electronic device includes a mode switching module, a signal receiving module, an instruction data base and a recognizing and figuring module. The mode switching module receives key pressing signal from the key to switch a controlled status of the electronic device between normal mode and special mode. The signal receiving module receives the touch signal and sends the touch signal to the recognizing and figuring module. The recognizing and figuring module recognizes touch coordinates, touch frequency or continuous locus under the special mode according to the touch signal, reads out the operational instruction and creates a control signal to call or execute an application software or program in the preset data saved in the instruction data base according to relation between the operational instruction and the control signal.

### BACKGROUND OF THE INVENTION

1. Field of the Invention

The present invention is related to an application software of an electronic device and particularly to an application software capable of expanding function of a touch pad on an electronic device.

2. Brief Description of the Related Art

Usually, when an application program or software in an electronic device such as internet explorer, email sending and receiving software or movie play program is opened, mostly an icon of the target folder is clicked with the mouse or a function key on the key board is pressed beforehand. The window on the screen of the electronic device can be moved by means of the scroll bar at the margin of the window being dragged upward, downward, leftward or rightward via the mouse or controlled with up, down, left and down arrow keys.

For certain mobile electronic device 10, which is not suitable for adapting the mouse, the touch pad 11 is used instead as shown in FIG. 1. The touch pad 11 in association with the left and right keys 12, 13 provides functions similar to the mouse such that a finger of the user moves on the touch pad 11 is equivalent to move the mouse to control the cursor 14 and the left and right keys 12, 13 being presses by the finger is equivalent to pressing the left and right arrow keys.

However, it is practically hard and awkward for the user to move the cursor 14 to the icon 15 or the scroll bar (not shown) precisely with the finger moving on the touch pad 11 due to the finger contacting an area greater than a specific spot on the touch pad 11. Under this circumstance, it takes time for the user to open the program or the application software and it results in the user always feels the scroll bar and folders on window screen are not controlled and operated easily and conveniently with touch pad 11.

In order to overcome the preceding problem related to dragging the scroll bar uneasily, alternative proposals of a scrolling mode and arrangement of specific block zones have been developed. That is, once the scrolling mode is set, the movements of up, down, left and right can be made on the touch pad to perform direction change of the window or the specific block zones are set as direction buttons for being pressed to perform the direction change of the window. Nevertheless, the problem related to layers of the folders being opened and related to icons being clicked uneasily is still not solved effectively.

### SUMMARY OF THE INVENTION

In order to solve the preceding problem, an object of the present invention is to provide a functional expansion system for a touch pad of an electronic device.

Another object of the present invention is to provide a method for expanding function of a touch pad of an electronic device.

A further object of the present invention is to provide an electronic device capable of allowing a touch pad thereof being operated conveniently.

Accordingly, a functional expansion system for a touch pad of an electronic device according to the present invention includes a mode switching module, a signal receiving module, an instruction data base and a recognizing and figuring module. The electronic device is set up or saved with multiple application software and programs and provides a touch pad and at least a key for inputting an operational instruction.

The mode switching module receives key pressing signal from the key and is operated to switch a controlled status of the electronic device between normal mode and special mode according to the pressing signal.

The signal receiving module receives touch signal from the touch pad and sends the touch signal to the recognizing and figuring module. Data related to the operational instruction corresponding control signal is preset in an instruction data base.

The recognizing and figuring module recognizes touch coordinates, touch frequency or continuous locus under the special mode according to the contact signal, reads out the operational instruction and creates a control signal to call or execute an application software or program in the preset data saved in the instruction data base according to data relation between the operational instruction and the control signal.

A method for expanding function of a touch pad of an electronic device according to the present invention, which has at least a key and is capable of calling or executing application software or programs thereof, includes following steps:
(A) setting up an instruction data base with a plurality of data, which are related to a specific operational instruction corresponding to a specific control signal respectively;
(B) receiving pressing signal of the key and touch signal from the touch pad;
(C) switching controlled status of the electronic device between a normal mode and a special mode according to the pressing signal;
(D) recognizing touch coordinates, touch frequency or continuous locus according to the contact signal and reading out the operation instruction; and
(E) creating the specific control signal to correspond to the specific operational instruction to call or execute one of the application software or programs based on the data in the instruction data base.

An electronic device according to the present invention includes a touch pad capable of creating touch signal while being point-hit or drawn a line, at least a key capable of creating key pressing signal while being pressed and the preceding functional expansion system for the touch pad.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of the conventional electronic device with a touch pad;

FIG. 2 is a black diagram illustrating a preferred embodiment of the electronic device according to the present invention;

FIG. 3 is a flow chart illustrating a method of functional expansion for the touch pad in the embodiment shown in FIG. 1;

FIG. 4 is a plan view illustrating an instruction being operated;

FIG. 5 is a plan view illustrating another instruction being operated; and

FIG. 6 is a plan view illustrating the second preferred embodiment of the touch pad according to the present invention and showing an instruction being operated.

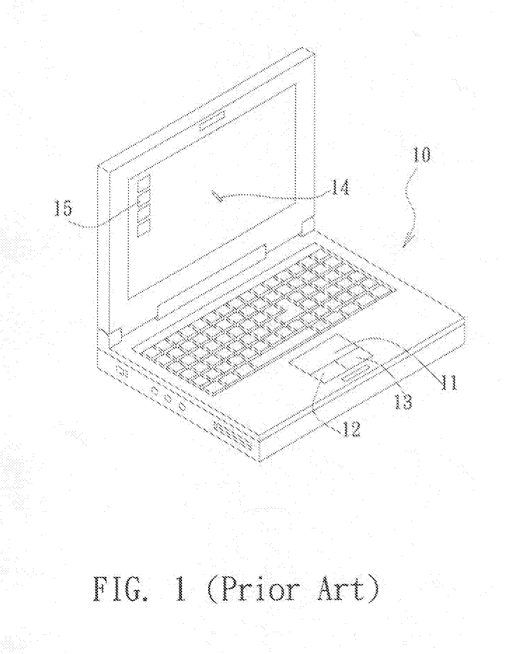

### DETAILED DESCRIPTION OF THE INVENTION

It is noted that same designated reference numerals is employed for similar parts in the following descriptions for the preferred embodiments.

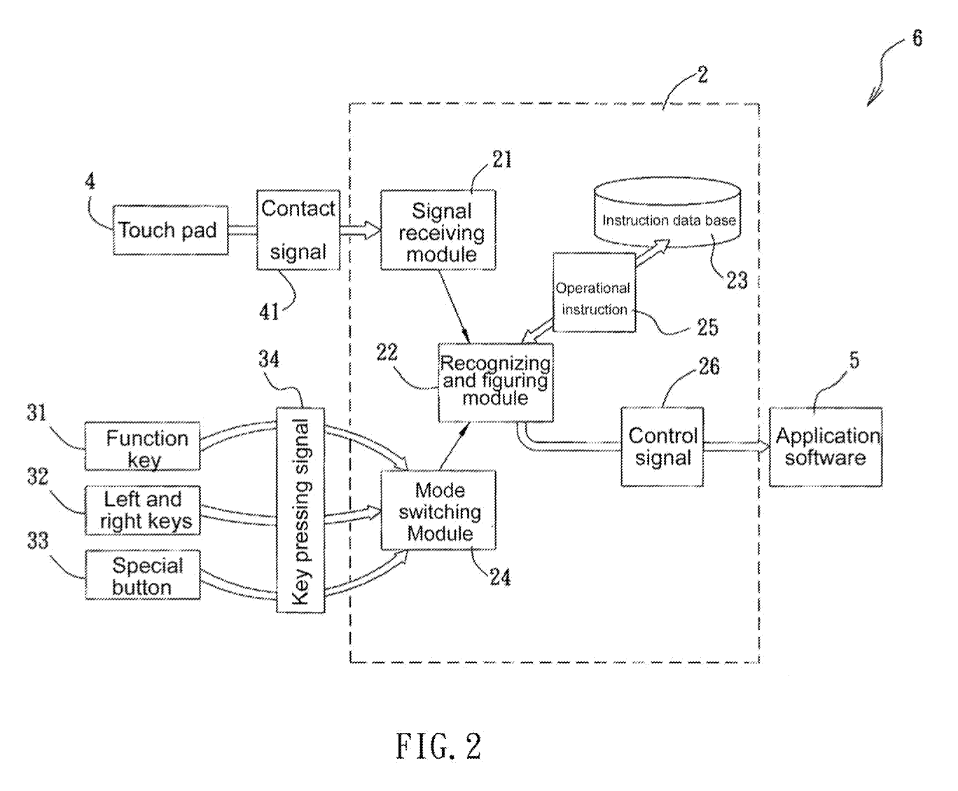

Referring to FIGS. 2 to 4, the first preferred embodiment of an electronic device 6 according to the present invention includes a plurality of keys, a touch pad 4 and a functional expansion system 2 for the touch pad 4 and application software with a plurality of programs 5. The application software and the programs 5 such as internet explorer, email software, movie player software and programs for controlling such as volume tuning, restoring movement and window scrolling are saved in the electronic device 6. Of course, the electronic device 6 includes the central processing unit, storage unit and screen display, which are not subject matters disclosed in the present invention and will not be further explanation hereinafter.

The touch pad 4 is available for the user to touch or draw lines with fingers 7 to create pressing signal 34. The keys illustrated in FIG. 2 includes an Fn function key 31, the left and right keys 32 next to the touch pad 4 and a special button 33 on the electronic device 6. The key arrangement shown in FIG. 2 is an example only and not for limiting implement of the invention.

The functional expansion system 2 includes a mode switch module 24 connecting with all the keys, a signal receiving module 21 connecting with the touch pad 4, an instruction data base 23 in which a plurality of default operational instructions corresponding to control signals being stored, and a recognizing and figuring module 22, which connecting with the mode switching module 24, the signal receiving module 21 and the instruction data base 23.

The mode switching module 24 receives key pressing signal 34 to allow controlled status of the electronic device 6 being switched between a normal mode and a special mode. The recognizing and figuring module 22 can recognize touch coordinates or touch frequency and continuous locus and can read out a specific operational instructions 25 to create a specific control signal 26 to call or execute an application software or program in the instruction data base 23 corresponding to the specific operational instructions 25.

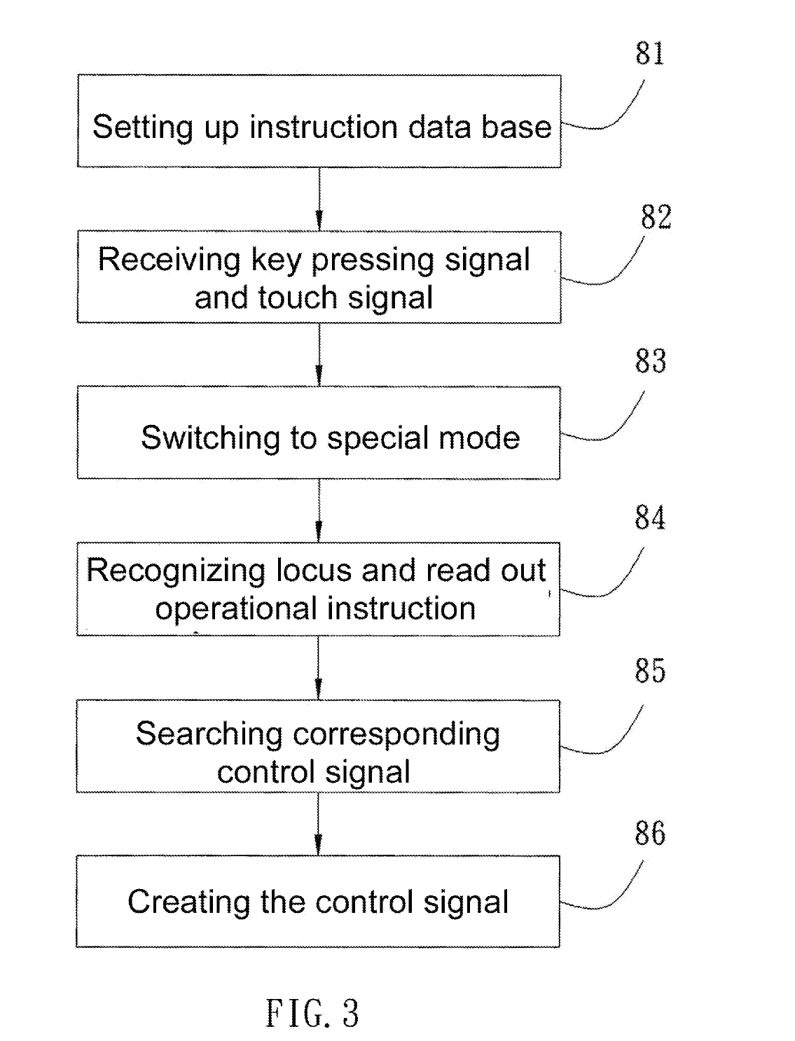

Referring to FIG. 3 in company with FIG. 2, establishment and execution steps of the system 2 is disclosed hereinafter.

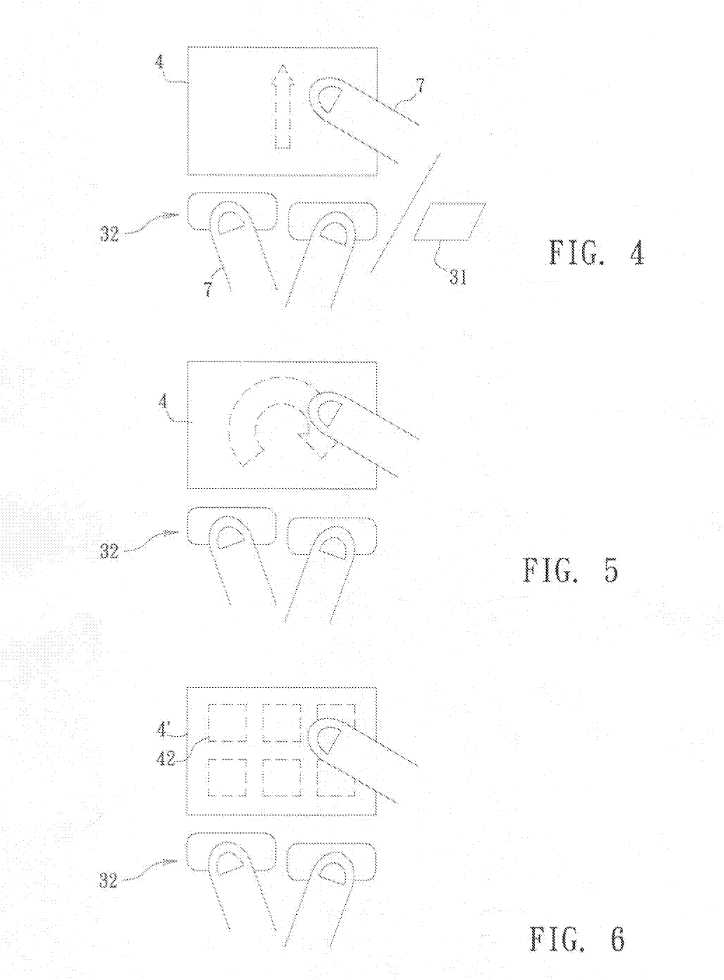

Step 81—the instruction data base is set up by the user with a plurality of default data related to the specific operational instruction 25 corresponding to the specific control signal 26 respectively. For instance, once the function key 31 or the left and right keys 32 or the special button 33 (not shown) is pressed as shown in FIGS. 4 and 5 after the electronic device 6 being switched to the special mode, one of the data can be designated to relate to that the specific operational instruction 25 is “(finger) sliding up and down on the touch pad” and the corresponding specific control signal 26 is “tuning the volume” or the specific operational instruction 25 is “(finger) making an circular arc counterclockwise/clockwise on the touch pad” and the corresponding control signal 26 is “restoring last movement/next movement”. Of course, designation of the data relating to the operational instruction 25 corresponding to the control signal 26 is not limited to the preceding examples and it can be “finger drawing a straight line from left to right, from upper left to lower right or from upper right to lower left and drawing a straight line reversing the preceding directions respectively” and the control signals 23 is “opening/closing a certain application program or scrolling the window screen”

Step 82—the mode switching module 24 receives key pressing signal 34 and the signal receiving module 21 receives touch signal 41 from the touch pad 4. The preceding movements can be operated sequentially or simultaneously. The key pressing signal 34 is obtained while the left and right keys 32 pressed simultaneously or the function key 31 or the special button 33 is pressed independently. The touch signal 41 is obtained while the finger slides rectilinearly on the touch pad 4 or draws a circular arc clockwise/counterclockwise on the touch pad 4.

Step 83—the mode switching module 24 switches the controlled status of the electronic device 6 from the normal mode to the special mode based on the key pressing signal 34.

Step 84—the recognizing and figuring module 22 recognizes the continuous locus of moving upward straightly or making a circular arc clockwise according to parameters of time and coordinates of the contacting signal 41, that is, the movement of the finger 7 on the touch pad 4 is read out. The recognizing and figuring module 22 further reads out the operational instruction 25 based on the learned locus in association with the received key pressing signal 34.

Step 85—the recognizing and figuring module 22 finds out data related to a control signal 26 corresponding to the operational instruction 25 obtained in step 84 via the instruction data base 23.

Step 86—the recognizing and figuring module 22 creates the control signal 26 with respect to one of the application software or programs in the data based on the result obtained from step 84 and the control signal 26 is capable of calling or executing the specific application software or program. That is, the instant step performs the preceding operational instruction such as volume modulation, movement restoration, opening/closing of a certain application program or scrolling of window.

Referring to FIG. 6, the second embodiment of the present invention is illustrated. The difference of the second embodiment from the first embodiment is in that the touch pad 4′ is arranged in accordance with the coordinates and provides a plurality of block zones 42. In case of the left and right keys 32, the function key 31 or the special button 33 being pressed and the controlled status of the electronic device 6 having been switched to the special mode, each block zone 42 being touched once/continuously means an operational instruction 25 is commanded to execute a default function such as opening the application software or executing the program.

In other words, it can be seen in FIG. 6 again in association with FIGS. 2 and 3 that data relating to the operational instruction 25 clicked on one of the block zones 42 of the touch pad 4′ corresponding to the control signal 26 is preset and saved in the instruction data base 23. The touch signal 41 is created with the finger 7 of the user touching one of the block zones once or continuously. Further, the recognizing and figuring module 22 recognizes the touched block zone 42 according to frequency and coordinates of the touch signal 41 in step 84 and data related to the operational instruction 25 corresponding control signal 26 is learned and the control signal 26 is created in steps 85 and 86 respectively.

It is appreciated that the functional expansion system 2 for a touch pad according to the present invention allows the touch pad 4, 4′ to provide more functions in addition to simply moving cursor on the window. Hence, only press specific keys and make specific gestures or movements on the touch pad 4 such as moving a specific direction and drawing a circular arc and then a preset software or program can be called or executed. In this way, facilitation of the touch pad 4 or the entire electronic device 6 can be enhanced for the user effectively.

While the invention has been described with referencing to preferred embodiments thereof, it is to be understood that modifications or variations may be easily made without departing from the spirit of this invention, which is defined by the appended claims.

What is claimed is:

1. A functional expansion system for a touch pad of an electronic device, which provides a plurality of software and programs and at least a key for inputting an operational instruction, comprising:
a mode switching module receiving a key pressing signal from the key to switch a controlled status of the electronic device between normal mode and special mode according to the pressing signal;
a signal receiving module connecting with the touch pad to receive a touch signal from the touch pad;
an instruction data base providing a plurality of preset data related to an operational instruction corresponding to a control signal; and
a recognizing and figuring module connecting with the mode switching module, the signal receiving module and the instruction data base respectively, recognizing one of parameters of touch coordinates, touch frequency and continuous locus under the special mode according to the touch signal, reading out the operational instruction and creating the control signal to call or execute an application software or program in the preset data saved in the instruction data base according to relation between the operational instruction and the control signal.

2. The functional expansion system for a touch pad of an electronic device as defined in claim 1, wherein the pressing signal is created by an user pressing a left key and a light key simultaneously, a function key independently or pressing a specific button independently on the electronic device.

3. The functional expansion system for a touch pad of an electronic device as defined in claim 1, wherein the touch signal is created by a user making a movement on the touch pad in a way of an unspecific area of the touch pad being finger-hit once or continuously, drawn a straight line or drawn a circular arc clockwise or counterclockwise, wherein the straight line is drawn downward, rightward, from upper left to lower right or from upper right to lower left or a reversed direction of the preceding movements respectively.

4. The functional expansion system for a touch pad of an electronic device as defined in claim 1, wherein the touch signal is created by a user making a movement on the touch pad in a way of an unspecific area of the touch pad being finger-hit once or continuously.

5. A method for expanding function of a touch pad of an electronic device which has at least a key and is capable of calling or executing application software or programs thereof, comprising following steps:
(A) setting up an instruction data base with a plurality of data related to an operational instruction corresponding to a control signal;
(B) receiving both key pressing signal and touch signal from the touch pad;
(C) switching controlled status of the electronic device between a normal mode and a special mode according to the pressing signal;
(D) recognizing touch coordinates, touch frequency or continuous locus according to the touch signal and reading out the operation instruction; and
(E) creating the control signal corresponding to the operational instruction to call or execute one of the application software or programs based on the data saved in the instruction data base.

6. The method for expanding function of a touch pad of an electronic device as defined in claim 5, wherein the pressing signal in step (B) is created by a user pressing a left key and a right key simultaneously, a function key independently or a specific button independently on the electronic device.

7. The method for expanding function of a touch pad of an electronic device as defined in claim 5, wherein the touch signal in step (B) is created by a user making a movement on the touch pad in a way of an unspecific area of the touch pad being finger-hit once or continuously, drawn a straight line or drawn a circular arc clockwise or counterclockwise, wherein the straight line is drawn downward, rightward, from upper left to lower right or from upper right to lower left or a reversed direction of the preceding movements respectively.

8. The method for expanding function of a touch pad of an electronic device as defined in claim 5, wherein the touch signal in step (B) is created by a user making a movement on the touch pad in a way of an unspecific area of the touch pad being finger-hit once or continuously.

9. An electronic device in which a plurality of application software and programs are set up or saved, comprising:
a touch pad creating touch signal while being point-hit or drawn a line;
at least a key creating pressing signal while being pressed; and
a functional expansion system for the touch pad; wherein the functional expansion system further comprises:
a mode switching module receiving the pressing signal and switching a controlled status of the electronic device between normal mode and special mode according to the pressing signal according to the pressing signal;
a signal receiving module connecting with the touch pad to receive the touch signal;
an instruction data base providing a plurality of preset data related to an operational instruction corresponding to a control signal; and
a recognizing and figuring module connecting with the mode switching module, the signal receiving module and the instruction data base respectively, recognizing one of parameters of touch coordinates, touch frequency and continuous locus under the special mode according to the touch signal, reading out the operational instruction and creating the control signal to call or execute an application software or program in the preset data saved in the instruction data base according to relation between the operational instruction and the control signal.

10. The electronic device as defined in claim 9, wherein the pressing signal is created by a user pressing a left key and a right key simultaneously, a function key independently or a specific button independently.

11. The electronic device as defined in claim 9, wherein the contact signal is created by a user making a movement on the touch pad in a way of an unspecific area of the touch pad being point-hit once or continuously, drawn a straight line or drawn a circular arc clockwise or counterclockwise, wherein the straight line is drawn downward, rightward, from upper left to lower right or from upper right to lower left or a reversed direction of the preceding movements respectively.

12. The electronic device as defined in claim 9, wherein the touch pad is arranged with coordinates and provides a plurality of block zones; the touch signal is created by a user making a movement in a way of an unspecific area of the touch pad being point-hit once or continuously; and the recognizing and figuring module recognizes coordinates of the touched spot.
